(19) United States
(12) Patent Application Publication
(10) Pub. No.: US 2019/0244143 A1
(43) Pub. Date: Aug. 8, 2019

(54) RESERVATION MANAGEMENT METHOD AND RESERVATION MANAGEMENT DEVICE

(71) Applicant: Panasonic Intellectual Property Corporation of America, Torrance, CA (US)

(72) Inventor: Haruhiko HABUTA, Osaka (JP)

(21) Appl. No.: 16/259,187

(22) Filed: Jan. 28, 2019

Related U.S. Application Data
(60) Provisional application No. 62/626,982, filed on Feb. 6, 2018.

(30) Foreign Application Priority Data
Nov. 14, 2018 (JP) 2018-214120

(51) Int. Cl. G06Q 10/02; G06Q 10/08

(52) U.S. Cl. CPC G06Q 10/02; G06Q 10/0836

(57) ABSTRACT

A reservation management method includes the following executed using a computer: obtaining item information from at least one compartment of a delivery cabinet or a communication terminal via a network, the item information indicating presence or absence of an item in the at least one compartment; and accepting a reservation for a first compartment from a delivery service provider, and declining a reservation for a second compartment from the delivery service provider, in a first time period starting after a first time from a current time, the first compartment being a compartment among the at least one compartment for which the item information indicates the absence of the item, the second compartment being a compartment among the at least one compartment for which the item information indicates the presence of the item.

### CROSS REFERENCE TO RELATED APPLICATION

This application claims the benefit of priority of U.S. Provisional Patent Application No. 62/626,982 filed on Feb. 6, 2018, and the benefit of priority of Japanese Patent Application Number 2018-214120 filed on Nov. 14, 2018, the entire contents of which are hereby incorporated by reference.

### BACKGROUND

### 1. Technical Field

The present disclosure relates to reservation management methods and reservation management devices.

### 2. Description of the Related Art

Patent Literature (PTL) 1 (Japanese Unexamined Patent Application Publication No. 2016-27461) discloses a revenue management system for selling rooms of accommodation facilities.

### SUMMARY

However, the technique according to PTL 1 needs further improvement.

In order to achieve the above object, a reservation management method according to one aspect of the present disclosure includes the following executed using a computer: obtaining item information from at least one compartment of a delivery cabinet or a communication terminal via a network, the item information indicating presence or absence of an item in the at least one compartment; and accepting a reservation for a first compartment from a delivery service provider, and declining a reservation for a second compartment from the delivery service provider, in a first time period starting after a first time from a current time, the first compartment being a compartment among the at least one compartment for which the item information indicates the absence of the item, the second compartment being a compartment among the at least one compartment for which the item information indicates the presence of the item.

It should be noted that these general or specific aspects may be realized by a system, a device, an integrated circuit, a computer program, or a computer-readable recording medium, such as a CD-ROM, and may be realized by any combination of a system, a device, an integrated circuit, a computer program, and a recording medium.

The present disclosure achieves further improvement.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a schematic view of a reservation management system according to Embodiment 1.

FIG. 2 is a block diagram illustrating one example of a functional configuration of the reservation management system according to Embodiment 1.

FIG. 3 is a diagram illustrating one example of a process for reserving a compartment of a delivery cabinet.

FIG. 4 is a diagram illustrating one example of reservation data according to Embodiment 1.

FIG. 5 is a view of one example of a delivery cabinet having compartments.

FIG. 6 is a view of one example of a delivery cabinet having a compartment

FIG. 7 is a diagram illustrating one example of a user interface (UI) for reserving a compartment of a delivery cabinet.

FIG. 8 is a diagram illustrating one example of a display indicating that compartment A of a delivery cabinet has been reserved.

FIG. 9 is a sequence diagram illustrating one example of operation by the reservation management system according to Embodiment 1.

FIG. 10 is a flowchart illustrating one example of a detailed step of transmitting item information by a delivery cabinet.

FIG. 11 is a flowchart illustrating one example of a detailed step of determining a current charge for use by a reservation management device.

FIG. 12 is a flowchart illustrating one example of a detailed step of generating reservation data by the reservation management device.

FIG. 13 is a diagram illustrating one example of a process for bidding for a compartment of a delivery cabinet by delivery service providers.

FIG. 14 is a sequence diagram illustrating one example of determining a charge according to a result of bidding in a reservation management system according to Embodiment 2.

FIG. 15 is a diagram illustrating one example of bidding by each terminal.

FIG. 16 is a diagram illustrating one example of reservation data including an attribute of each compartment of a delivery cabinet.

FIG. 17 is a diagram illustrating one example of a UI for a delivery service provider to input an attribute of an item to be delivered.

FIG. 18 is a diagram illustrating one example of a UI for reserving compartment A.

FIG. 19 is a diagram illustrating one example of reservation data including an attribute of each compartment of a delivery cabinet.

### DETAILED DESCRIPTION OF THE EMBODIMENTS

(Underlying Knowledge Forming Basis of the Present Disclosure)

The inventor has found that the following problem occurs with the revenue management system described in the “BACKGROUND” section.

By optimizing prices of rooms of accommodation facilities, the revenue management system disclosed in PTL 1 efficiently sells rooms to reduce the number of vacant rooms.

In recent years, delivery cabinets for handing items delivered by delivery service providers to recipients have become widespread. A delivery service provider places an item in a compartment of a delivery cabinet predesignated by a recipient, and the recipient obtains the item placed in the compartment. In this manner, the delivery service provider can hand the item to the recipient via the compartment. In other words, the delivery service provider can deliver the item even when the recipient is absent at the place of delivery, and thus the delivery service provider can save time and effort for redelivery when the recipient is absent.

However, under the existing circumstances, recipients can receive items by asking delivery service providers for redelivery, and thus the recipients gain less economic benefits from installation of delivery cabinets than the delivery service providers. For this reason, only a certain number of delivery cabinets has become widespread.

In view of this, in order to promote the widespread use of delivery cabinets, the present disclosure has an object to provide a reservation management method and a reservation management device for delivery cabinets that can offer economic benefits to delivery cabinet owners. In addition, the present disclosure provides the reservation management method and the reservation management device that can reduce energy consumption for delivery by delivery service providers.

A reservation management method according to one aspect of the present disclosure includes the following executed using a computer: obtaining item information from at least one compartment of a delivery cabinet or a communication terminal via a network, the item information indicating presence or absence of an item in the at least one compartment; and accepting a reservation for a first compartment from a delivery service provider, and declining a reservation for a second compartment from the delivery service provider, in a first time period starting after a first time from a current time, the first compartment being a compartment among the at least one compartment for which the item information indicates the absence of the item, the second compartment being a compartment among the at least one compartment for which the item information indicates the presence of the item.

With this configuration, item information is obtained that indicates the presence or absence of an item in a compartment of a delivery cabinet, a reservation for a compartment of a delivery cabinet in which an item is already placed is declined, and a reservation for a compartment of the delivery cabinet in which an item is not placed is accepted. For this reason, it is possible to efficiently increase a use rate of the compartment. In addition, a delivery service provider can deliver an item to a reserved compartment of a delivery cabinet and place the item in the reserved compartment without looking for an available compartment. Accordingly, for example, the delivery service provider can decrease a distance traveled for delivery by a vehicle in order to look for the available compartment, and reduce the energy consumption of the vehicle.

Moreover, the reservation management method may further include regularly determining, for each of the at least one compartment, a current charge for use of the compartment according to demand information relating to a current demand for the compartment, and in the accepting of the reservation, a reservation for the at least one compartment may be accepted at the current charge determined in the regularly determining.

With this configuration, since a charge for a compartment of a delivery cabinet is varied according to demand information about a demand for the compartment, it is possible to appropriately adjust the charge so as to increase profits from the charge of the compartment.

Moreover, the demand information may indicate at least one of a use record of the at least one compartment, a use rate of compartments of other delivery cabinets in the vicinity of the delivery cabinet, a time of year when reservations are made, an installation position of the delivery cabinet, and an attribute of the at least one compartment.

With this configuration, it is possible to appropriately adjust a charge of a compartment of a delivery cabinet according to at least one of a use record of the compartment, a use rate of compartments of other delivery cabinets in the vicinity of the delivery cabinet, a time of year when reservations are made, an installation position of the delivery cabinet, and an attribute of the compartment.

Moreover, in the regularly determining, the current charge may be determined so as to be a highest charge according to the use record of the at least one compartment.

With this configuration, it is possible to appropriately adjust a charge for a compartment of a delivery cabinet so as to increase profits from the charge of the compartment.

Moreover, the accepting of the reservation may include: receiving bids for the first compartment together with requests for the reservation for the first compartment from delivery service providers until a time before a second time from a starting time of the first time period; and accepting the reservation for the first compartment that corresponds to one of the requests that is received with a highest bid of a highest bid price among bid prices respectively indicated by the bids. The reservation management method may further include determining a charge for use of the first compartment so as to be the highest bid price in the first time period.

With this configuration, it is possible to easily set a charge for a compartment of a delivery cabinet to be a higher price.

Moreover, in the accepting of the reservation, when there are a plurality of highest bids, one of requests for the reservation for the first compartment corresponding to the plurality of highest bids may be randomly selected, and the randomly selected reservation request may be accepted as the reservation for the first compartment.

With this configuration, it is possible to easily accept a reservation.

Moreover, the reservation management method may further include obtaining an attribute associated with the first compartment of the delivery cabinet, wherein the accepting of the reservation may include, regarding a request for the reservation for the first compartment: obtaining, together with the request, an attribute of an item to be delivered by the delivery service provider; and limiting the reservation for the first compartment in accordance with the obtained attribute of the item and the attribute of the first compartment.

With this configuration, a delivery service provider can easily reserve a compartment of a delivery cabinet that has an attribute suitable to an attribute of an item without looking for the compartment having the suitable attribute. Accordingly, for example, the delivery service provider can decrease a distance traveled for delivery by a vehicle in order to look for the compartment having the attribute suitable to the attribute of the item, and reduce the energy consumption of the vehicle.

Moreover, in the limiting, the obtained attribute of the item and the attribute of the first compartment may be compared, and when the obtained attribute of the item and the attribute of the first compartment are not in a predetermined correspondence relationship, the reservation for the first compartment necessary for delivering the item may be limited by prohibiting the reservation for the at least one compartment.

With this configuration, since a delivery service provider cannot reserve a compartment of a delivery cabinet that has an attribute having no correspondence relationship with an attribute of an item, it is possible to prevent delivery of an item to a compartment of a delivery cabinet that has an unsuitable attribute.

Moreover, in the accepting of the reservation, when requests for the reservation for the first compartment are received from delivery service providers until a time before a second time from a starting time of the first time period, a reservation request may be accepted as the reservation for the first compartment from among the requests, the reservation request having a highest predetermined priority of the obtained attribute of the item relative to the obtained attribute of the first compartment.

With this configuration, for example, when a priority is set higher when a recipient is an owner of a compartment of a delivery cabinet, delivery service providers use the compartment when delivering an item for the owner. Accordingly, it is possible to improve the convenience of owners and promote the widespread use of delivery cabinets.

It should be noted that these general or specific aspects may be realized by a system, a method, an integrated circuit, a computer program, or a computer-readable recording medium, such as a CD-ROM, and may be realized by any combination of a system, a method, an integrated circuit, a computer program, and a recording medium.

Hereinafter, a reservation management method and a reservation management device according to one aspect of the present disclosure will be described in detail with reference to the drawings.

It should be noted that each of embodiments to be described below represents a specific example of the present disclosure. The numerical values, shapes, materials, structural components, the arrangement and connection of the structural components, steps, the order of the steps, etc. shown in the following embodiments are mere examples, and are not intended to limit the scope of the present disclosure. Furthermore, among the structural components in the following embodiments, structural components not recited in any one of the independent claims which indicate the broadest concepts of the present disclosure are described as optional structural components.

### Embodiment 1

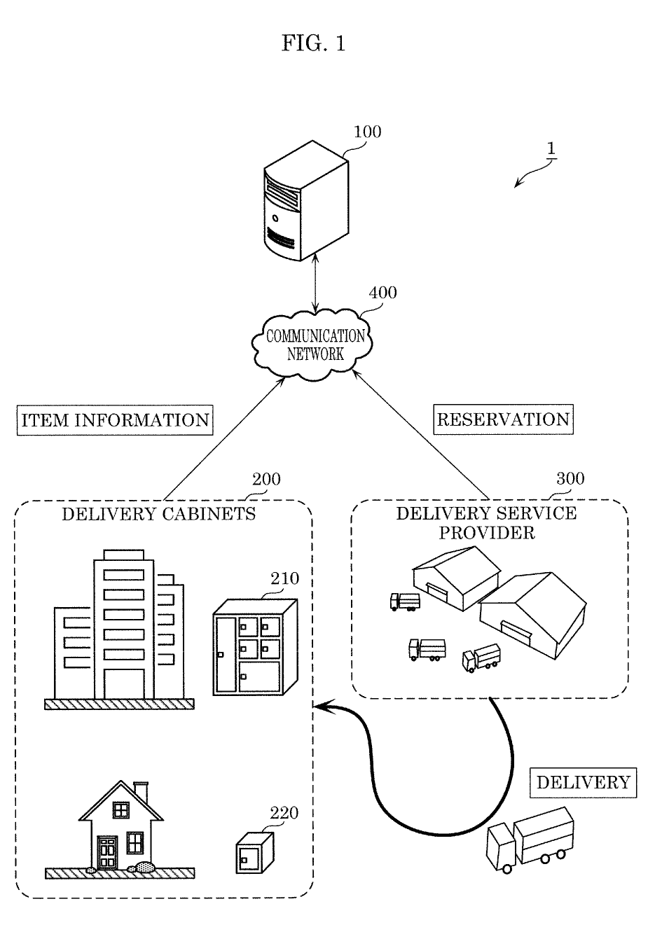

Hereinafter, Embodiment 1 will be described with reference to FIG. 1 to FIG. 12.

[1-1. Configuration]

FIG. 1 is a schematic view of a reservation management system according to Embodiment 1.

Specifically, FIG. 1 shows reservation management device 100, delivery cabinets 200, delivery service provider 300, and communication network 400. For example, reservation management system 1 includes, among these structural components, reservation management device 100, delivery cabinets 200, and delivery service provider 300.

Reservation management device 100 accepts reservations for delivery cabinets 200 from delivery service providers according to the status of use of delivery cabinets 200. Reservation management device 100 includes, for example, a computer and is, for example, a server.

Delivery cabinets 200 include first delivery cabinet 210 and second delivery cabinet 220. First delivery cabinet 210 is installed in a multidwelling unit or in public facilities, such as a station, an airport, accommodation facilities, and commercial facilities. First delivery cabinet 210 has compartments. Second delivery cabinet 220 is installed in, for example, a private house. Second delivery cabinet 220 has a compartment. It should be noted that second delivery cabinet 220 may have compartments. First delivery cabinet 210 and second delivery cabinet 220 have a communication function and a function of detecting an item in each of the compartments, and transmit item information indicating item's presence or absence to reservation management device 100 via communication network 400 using the communication function. First delivery cabinet 210 and second delivery cabinet 220 regularly generate item information and transmit the generated item information to reservation management device 100.

Delivery service provider 300 delivers items to places of delivery designated by customers. Delivery service provider 300 delivers items using a vehicle such as a truck. Delivery service provider 300 reserves delivery cabinets 200 to reservation management device 100 via communication network 400 using an information terminal, and delivers items to reserved delivery cabinets 200. The details of the information terminal will be described later.

Communication network 400 may be a general-purpose network, such as the Internet, or a dedicated network. Communication network 400 may include mobile telecommunications technology, such as the third generation of wireless mobile telecommunications technology (3G), the fourth generation of wireless mobile telecommunications technology (4G), the fifth generation of wireless mobile telecommunications technology (5G), or LTE (registered trademark).

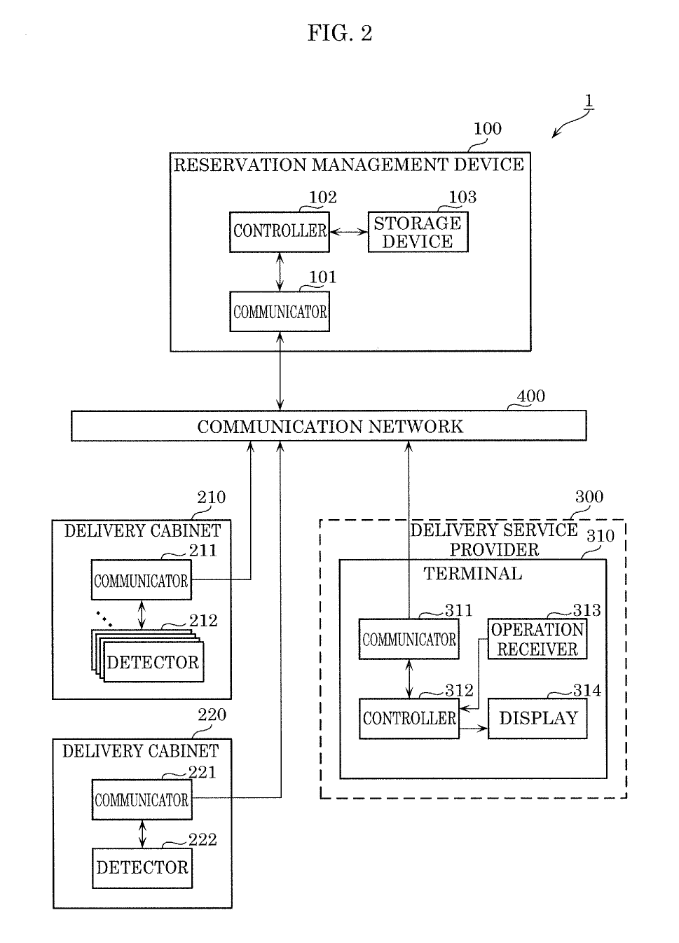

Next, the following describes a functional configuration of reservation management system 1 with reference to FIG. 2.

FIG. 2 is a block diagram illustrating one example of a functional configuration of the reservation management system according to Embodiment 1.

First, the functional configuration of reservation management device 100 will be described.

Reservation management device 100 includes communicator 101, controller 102, and storage device 103.

Communicator 101 is realized as a communication interface that communicates with delivery cabinets 200 and terminal 310 of delivery service provider 300 via communication network 400. Communicator 101 obtains item information indicating item's presence or absence in at least one delivery cabinet 200 from at least one delivery cabinet 200 via the communication network. Moreover, communicator 101 receives a request for reservation data to be described from terminal 310 via communication network 400, and transmits reservation data stored in storage device 103 to terminal 310 via communication network 400. Furthermore, communicator 101 receives a reservation request for a compartment of at least one delivery cabinet 200 from terminal 310. In addition, when communicator 101 accepts the reservation, communicator 101 may issue an unlock key for opening the reserved compartment to terminal 310, which has transmitted the reservation request corresponding to the reservation.

It should be noted that the communication interface, which serves as communicator 101, is, for example, a wired LAN interface. It should also be noted that the communication interface may be a wireless LAN interface. Further, the communication interface is not limited to an LAN interface, and may be any communication interface as long as the communication interface can establish communication with a communication network.

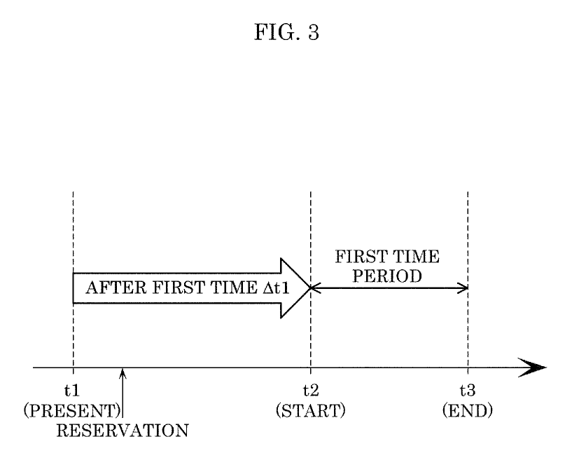

Controller 102 limits a reservation for the compartment corresponding to the item information received by communicator 101, according to the item information. Here, a reservation for a compartment of a delivery cabinet will be described with reference to FIG. 3.

FIG. 3 is a diagram illustrating one example of a process for reserving a compartment of a delivery cabinet.

A reservation is a reservation for use of any compartment of a delivery cabinet in a first time period ranging from starting time t2 to ending time t3, starting time t2 being after a first time from current time t1. First time Δt1 may be set to, for example, a fixed time with reference to a time required for a delivery service provider to deliver a predetermined item to a delivery cabinet, and a time dynamically calculated according to a distance between the current position of a delivery service provider and the installation position of a delivery cabinet whose compartment is to be reserved. The first time period may be set to a fixed time such as a day or two. Further, end time t3 of the first time period need not be determined when a reservation is made, and may be, for example, a time when a recipient picks up an item in a compartment of a delivery cabinet.

Return back to the description of controller 102 with reference to FIG. 2.

In the limiting of the reservation, controller 102 accepts via communicator 101 a reservation for at least one first compartment of at least one delivery cabinet 200 from a delivery service provider in the first time period that starts after first time Δt1 from current time t1, the at least one first compartment being a compartment for which item information indicates item's absence. In contrast, in the limiting of the reservation, controller 102 declines a reservation for at least one second compartment of at least one delivery cabinet 200 from the delivery service provider in the first time period that starts after first time Δt1 from current time t1, the at least one second compartment being a compartment for which item information indicates item's presence.

In other words, controller 10 determines, for example, whether item information received from a compartment of a delivery cabinet by communicator 101 indicates “item's absence” in the compartment. In the case where the determination result shows that the item information indicates “item's absence,” when communicator 101 receives a reservation request for the compartment from terminal 310, controller 102 accepts the reservation for the compartment made by terminal 310. On the contrary, when the determination result shows that the item information indicates “item's presence,” controller 102 performs control so that the reservation for the compartment is not accepted. Specifically, controller 102 may generate reservation data that are used for receiving a reservation request from terminal 310 and indicate the current reservation availability of compartments of a delivery cabinet. The reservation data are data generated so that a reservation request for one of the compartments cannot be made.

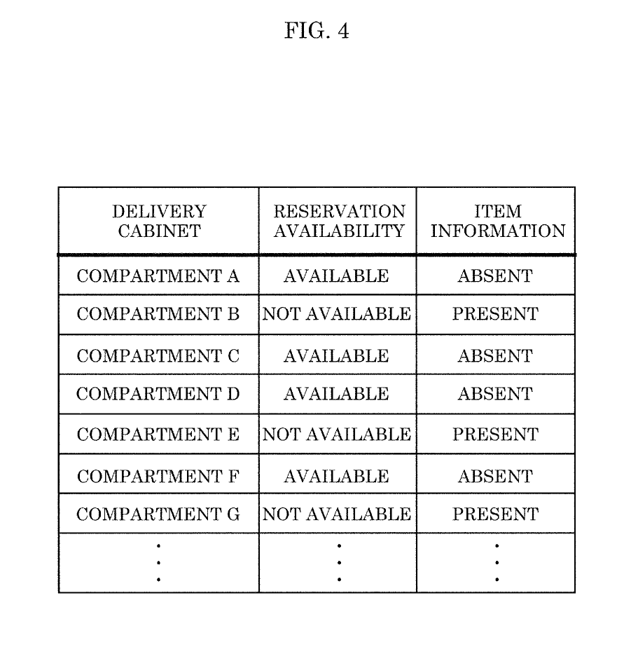

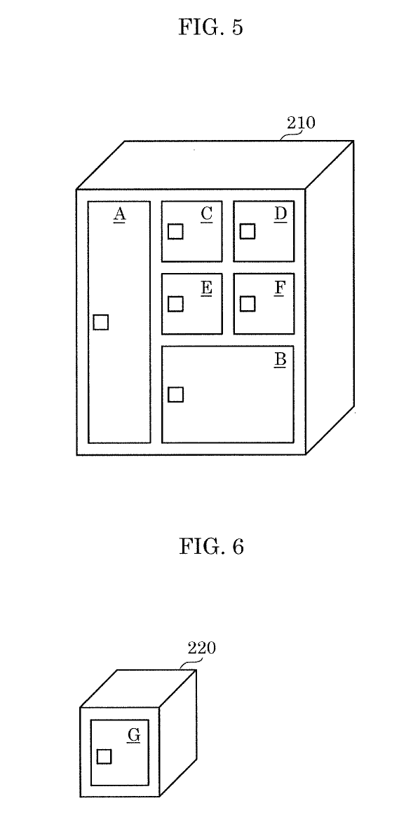

As shown in FIG. 4, reservation availability is determined for each of compartments A to G (see FIG. 5 and FIG. 6 to be described) of delivery cabinets 210 and 220 according to, for example, item information of each of compartments A to G. In other words, the reservation data indicate that any compartment, for which item information indicates “item's absence,” can be reserved, and that any compartment, for which item information indicates “item's presence,” cannot be reserved. In addition, the reservation data indicate that any compartment already reserved cannot be reserved even if item information indicates “item's absence” for the compartment. Besides, though not shown, the reservation data may include information indicating the installation position of each of delivery cabinets 210 and 220 having compartments A to G.

It should be noted that controller 102 may generate reservation data excluding information about any compartment that cannot be reserved. In other words, controller 102 may prohibit the reservation request for the compartment from being made by excluding the compartment from the reservation data for making the reservation request.

Moreover, controller 102 may obtain position information indicating the position of a place of delivery of an item to be delivered by a delivery service provider from terminal 310 of the delivery service provider via communicator 101, and may extract any delivery cabinet within a predetermined area with reference to the position of the place of delivery indicated by the obtained position information. Subsequently, controller 102 may generate reservation data about the extracted delivery cabinet and transmit the generated reservation data to terminal 310 via communicator 101.

Moreover, controller 102 may regularly determine the current charge for use of each of compartments of at least one delivery cabinet according to demand information relating to the current demand for the compartment. Accordingly, controller 102 accepts a reservation at the determined current charge. Here, the demand information used for determining the current charge for use of each compartment indicates at least one of a use record of the compartment, a use rate of compartments of other delivery cabinets in the vicinity of the at least one delivery cabinet, a time of year when reservations are made, the installation position of the at least one delivery cabinet, and an attribute of the compartment.

Controller 102 may determine the current charge so as to be the highest charge according to the use record of each compartment. For example, controller 102 may determine the highest charge according to the use record as the current charge, and may determine the highest charge according to a use record in each of times of year as a charge in the time of year.

Moreover, controller 102 may determine the current charge for use of each compartment of the at least one delivery cabinet so as to be a higher charge with an increase in the use rate of the compartments of the other delivery cabinets in the vicinity of the at least delivery cabinet. Further, for example, controller 102 may determine a charge in each of times of year according to a demand projection of the compartment in each time of year or a demand projection for the compartments of the other delivery cabinets in the vicinity of the at least one delivery cabinet. In this case, controller 102 may determine a charge that gets higher as a demand projection corresponding to a time of year when reservations are to be made is greater. A demand projection may be obtained by, for example, calculating an average of use rates, a median value of the use rates, etc. on the basis of the use records of the compartment of the at least one delivery cabinet and the compartments of the other delivery cabinets in the vicinity of the at least delivery cabinet. For example, controller 102 may determine a charge for use of the compartment so as to be a charge that gets higher as the nonresident population in a predetermined area including the installation position of the at least one delivery cabinet is larger, according to the installation position. In addition, for example, when an attribute of the compartment indicates that the compartment has a function of refrigeration or freezing, controller 102 may determine a charge for use of the compartment as being higher than charges for use of the other compartments indicating different attributes.

It should be noted that controller 102 may be realized as a processor that executes a predetermined program and a memory that stores a predetermined program, or may be realized as a dedicated circuit. In other words, controller 102 may be realized as software or hardware.

Storage device 103 may store information required by a processor, such as a program. Storage device 103 may store data resulting from processing by a processor, such as reservation data. Storage device 103 may be realized as a nonvolatile storage device, such as a flash memory and a hard disk drive (HDD).

Delivery cabinet 210 functionally includes communicator 211 and detectors 212. Here, as shown in FIG. 5, delivery cabinet 210 has compartments A to F. FIG. 5 is a view of one example of a delivery cabinet having compartments.

Detectors 212 are each provided to a corresponding one of compartments A to F, and detect an item in the corresponding one of compartments of A to F. Detectors 212 may regularly perform detection. Moreover, when a sensor is separately provided that detects opening and closing of the door of each of compartments A to F, detectors 212 may perform detection every time the door of each of compartments A to F opens and closes, according to a detection result of the sensor. Further, detectors 212 may always continue to output a detection result.

For example, each of detectors 212 may be an object detection sensor that detects an object, such as an infrared sensor, or may be a camera. Further, each of detectors 212 may include a switch that switches between ON and OFF, and may detect an item in a compartment by turning the switch ON when a delivery service provider places an item and turning the switch OFF when a recipient picks up an item.

Communicator 211 transmits detection results of detectors 212 as item information to reservation management device 100 via communication network 400. Every time the detection results of detectors 212 are outputted, communicator 211 transmits the item information indicating the detection results to reservation management device 100. Further, when detectors 212 always continue to output detection results, communicator 211 may transmit the then detection results as item information to reservation management device 100. It should be noted that communicator 211 need not transmit all the detection results as item information to reservation management device 100, and may transmit, among detection results, only changed detection results as item information to reservation management device 100. In this case, communicator 211 may include a memory for holding previous detection results.

It should be noted that communicator 211 is realized as a communication interface that communicates with reservation management device 100 via communication network 400. The communication interface, which serves as communicator 211, is, for example, a wired LAN interface. It should also be noted that the communication interface may be a wireless LAN interface. Further, the communication interface is not limited to an LAN interface, and may be any communication interface as long as the communication interface can establish communication with a communication network. Moreover, communicator 211 may be realized as a processor that executes a predetermined program and a memory that stores a predetermined program, or may be realized as a dedicated circuit. In other words, communicator 211 may be realized as software or hardware.

Delivery cabinet 220 functionally includes communicator 221 and detector 222. Here, as shown in FIG. 6, delivery cabinet 220 has compartment G. FIG. 6 is a view of one example of a delivery cabinet having a compartment.

Delivery cabinet 220 differs from delivery cabinet 210 in including compartment G and detector 222 corresponding to compartment G. The other configuration of delivery cabinet 220 is the same as that of delivery cabinet 210, and thus description thereof is omitted.

Delivery service provider 300 has terminal 310 for reserving the compartments of delivery cabinets 210 and 220. Terminal 310 is, for example, a smartphone, a table terminal, and a computer such as a laptop personal computer (PC). By operating terminal 310, delivery service provider 300 may select and reserve one of at least one designated delivery cabinets predesignated by a recipient. Further, by operating terminal 310, delivery service provider 300 may select and reserve one of designated delivery cabinets within a predetermined area with reference to the address of a recipient. In addition, by operating terminal 310, delivery service provider 300 may select and reserve one of designated delivery cabinets within a predetermined area with reference to an address predesignated by a recipient.

Terminal 310 functionally includes communicator 311, controller 312, operation receiver 313, and display 314.

Communicator 311 is realized as a communication interface that communicates with reservation management device 100 via communication network 400. Specifically, communicator 311 transmits a transmission request for reservation data to reservation management device 100 in response to an operation received by operation receiver 313. It should be noted that a transmission request for reservation data may include position information indicating a place of delivery of an item to be delivered by a delivery service provider. Moreover, communicator 311 receives reservation data from reservation management device 100. Furthermore, communicator 311 transmits a reservation request for a compartment of a delivery cabinet to reservation management device 100. Moreover, communicator 311 receives an unlock key for the compartment of the delivery cabinet. Furthermore, communicator 311 may receive from reservation management device 100 a notification indicating that the reservation has been made.

It should be noted that the communication interface, which serves as communicator 311, may be a communication interface that can establish a communication connection to communication network 400. Specifically, the communication interface establishes a communication connection to communication network 400 through a communication connection to a base station of a mobile communication system. The communication interface may be compliant with communications standards used in mobile telecommunications technology, such as the third generation of wireless mobile telecommunications technology (3G), the fourth generation of wireless mobile telecommunications technology (4G), the fifth generation of wireless mobile telecommunications technology (5G), or LTE (registered trademark). Further, the communication interface may be a wireless local area network (LAN) interface compliant with, for example, IEEE 802.11a, b, g, n, ac standards, and may be a communication interface that establishes a communication connection to communication network 400 through a communication connection to a router (e.g., a mobile wireless LAN router) that is not shown.

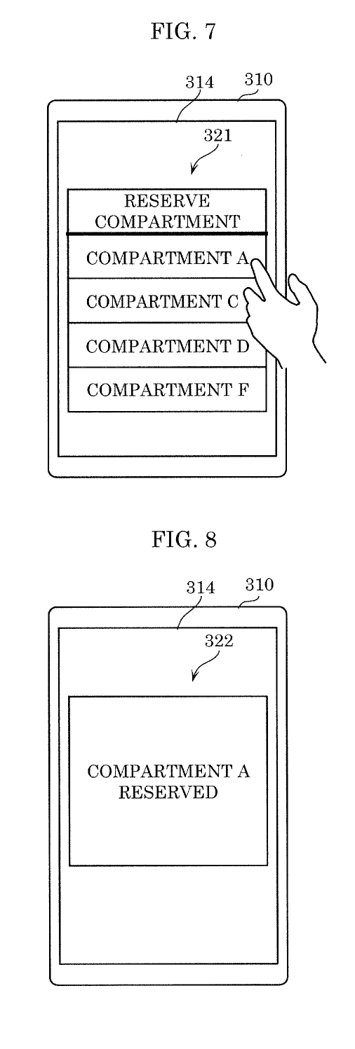

As shown in FIG. 7, by executing a predetermined application, controller 312 causes display 314 to display, for example, user interface (UI) 321 for reserving a compartment of a delivery cabinet, according to reservation data received by communicator 311. FIG. 7 is a diagram illustrating one example of a user interface (UI) for reserving a compartment of a delivery cabinet. By causing UI 321 to display, among compartments A to G, only compartments A, C, D, and F that can be reserved according to the reservation data, controller 312 allows an operation indicating a reservation request for each of compartments A, C, D, and F from a delivery service provider, and prohibits an operation indicating a reservation request for each of compartments B, E, and G that cannot be reserved from the delivery service provider.

It should be noted that although UI 321 shown in FIG. 7 does not display a charge for each of compartments A, C, D, and F, UI 321 may display the charge. Accordingly, the delivery service provider can select a desired compartment according to the displayed charge. Moreover, UI 321 shown in FIG. 7 may display information indicating the installation position of delivery cabinet 210 having compartments A, C, D, and F. Accordingly, the delivery service provider can select a desired compartment according to the displayed installation position. When UI 321 is caused to display charges as shown above, reservation management device 100 generates reservation data further including determined charges. Further, when UI 321 is caused to display the installation position of the delivery cabinet, reservation management device 100 generates reservation data further including the installation position of the delivery cabinet.

Moreover, when operation receiver 313 receives an operation to select compartment A as shown in FIG. 7, controller 312 causes communicator 311 to transmit the reservation request for compartment A to reservation management device 100. When communicator 311 receives information indicating that the reservation has been made as shown in FIG. 8, controller 312 may cause display 314 to display UI 322 displaying the information. FIG. 8 is a diagram illustrating one example of a display indicating that compartment A of a delivery cabinet has been reserved.

It should be noted that controller 312 may be realized as a processor that executes a predetermined program and a memory that stores a predetermined program, or may be realized as a dedicated circuit. In other words, controller 312 may be realized as software or hardware.

Operation receiver 313 receives an operation to UI 321 displayed by display 314. For example, operation receiver 313 may be realized as a touch panel disposed overlapping with display 314, or may be realized as another pointing device. Moreover, operation receiver 313 may be realized as a microphone and a processor, and may receive an operation to UI 321 by recognizing voice obtained by the microphone.

Display 314 displays, for example, UIs 321 and 322 outputted by controller 312. Display 314 is realized as, for example, a liquid crystal display and an organic electroluminescent (EL) display.

[1-2. Operation]

Next, the following describes operation by reservation management system 1 according to Embodiment 1.

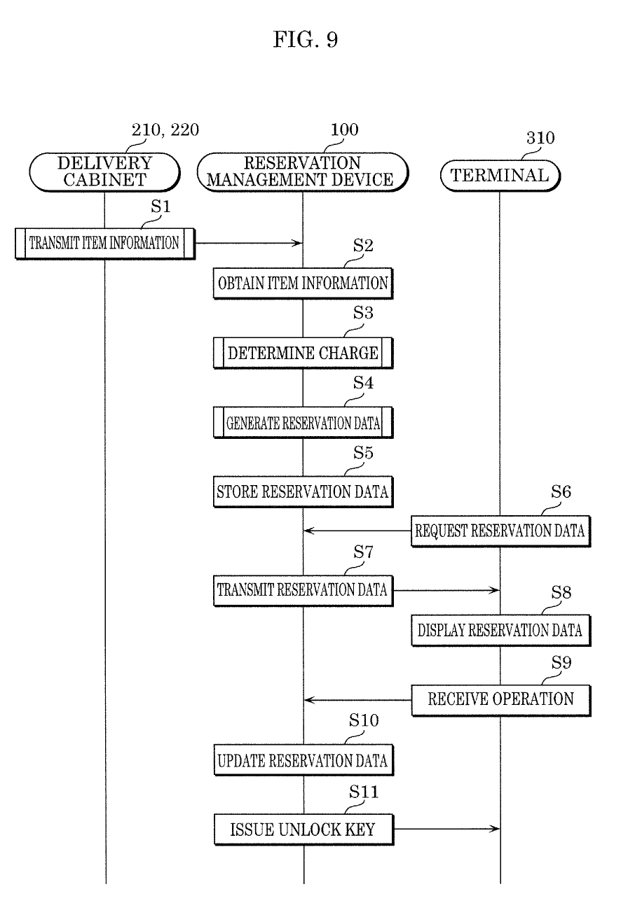

FIG. 9 is a sequence diagram illustrating one example of operation by the reservation management system according to Embodiment 1.

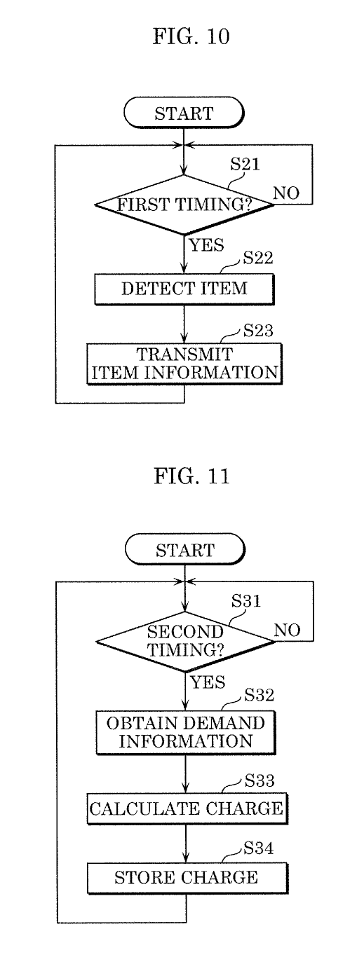

First, in delivery cabinets 210 and 220, communicators 211 and 221 transmit item information, detection results of detectors 212 and detector 222, to reservation management device 100 (S1). It should be noted that a step of transmitting item information will be described in detail with reference to FIG. 10. Here, a case of delivery cabinet 210 is described as an example. A case of delivery cabinet 220 can be also described in a similar manner.

FIG. 10 is a flowchart illustrating one example of a detailed step of transmitting item information by a delivery cabinet.

Delivery cabinet 210 determines whether the present time is a first timing (S21). The first timing is, for example, a timing repeated in a predetermined cycle, and a predetermined timing. Delivery cabinet 210 may count for each unit of time since delivery cabinet 210 determined last time that the present time was the first timing, and may determine, as the first timing, a timing at which the number of counts corresponding to a predetermined time is counted.

When delivery cabinet 210 determines that the present time is the first timing (YES in S21), delivery cabinet 210 detects an item inside thereof. When delivery cabinet 210 determines that the present time is not the first timing (NO in S21), delivery cabinet 210 returns to step S21.

Delivery cabinet 210 transmits item information indicating an item detection result to reservation management device 100 (S23).

In this manner, delivery cabinet 210 regularly transmits item information to reservation management device 100. In other words, delivery cabinet 210 regularly transmits item information to reservation management device 100 regardless of the timing shown in the sequence diagram of FIG. 9.

Return back to the description of FIG. 9.

Next, in reservation management device 100, communicator 101 obtains the item information transmitted from each of delivery cabinets 210 and 220 (S2).

Then, controller 102 regularly determines, for each of compartments of at least one delivery cabinet, the current charge for use of the compartment according to demand information relating to the current demand for the compartment (S3). It should be noted that a step of determining the current charge will be described in detail with reference to FIG. 11.

FIG. 11 is a flowchart illustrating one example of a detailed step of determining a current charge for use by a reservation management device.

Reservation management device 100 determines whether the present time is a second timing (S31). The second timing is, for example, a timing repeated in a predetermined cycle, and a predetermined timing. Reservation management device 100 may count for each unit of time since reservation management device 100 determined last time that the present time was the second timing, and may determine, as the second timing, a timing at which the number of counts corresponding to a predetermined time is counted.

When reservation management device 100 determines that the present time is the second timing (YES in S31), reservation management device 100 obtains demand information (S32). In other words, reservation management device 100 obtains the demand information at the second timing. When reservation management device 100 determines that the present time is not the second timing (NO in S31), reservation management device 100 returns to step S31.

Reservation management device 100 calculates the current charge for use of each compartment of the at least one delivery cabinet according to the demand information at the second timing (S33).

Reservation management device 100 stores the calculated charge into storage device 103 (S34). When a charge is included in reservation data already stored in storage device 103, reservation management device 100 may store the charge calculated in step S33 into storage device 103 by updating the charge to the charge calculated in step S33.

In this manner, reservation management device 100 regularly updates a charge, and the updating need not be performed after step S2 or before step S4 as shown in FIG. 9.

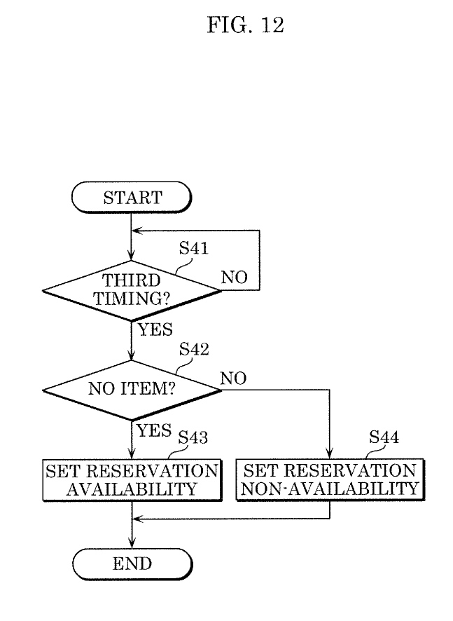

Controller 102 generates reservation data according to the obtained item information (S4). It should be noted that a step of generating reservation data will be described in detail with reference to FIG. 12.

FIG. 12 is a flowchart illustrating one example of a detailed step of generating reservation data by the reservation management device.

Reservation management device 100 determines whether the present time is a third timing (S41). The third timing is, for example, a timing repeated in a predetermined cycle, and a predetermined timing. Reservation management device 100 may count for each unit of time since reservation management device 100 determined last time that the present time was the third timing, and may determine, as the third timing, a timing at which the number of counts corresponding to a predetermined time is counted. It should be noted that the first to third timings may be different timings or the same timing. Further, the predetermined time counted at each of the first to third timings may be a different time or the same time.

When reservation management device 100 determines that the present time is the third timing (YES in S41), reservation management device 100 determines whether the obtained item information indicates “item's absence” (S42). When reservation management device 100 determines that the present time is not the third timing (NO in S41), reservation management device 100 returns to step S41.

When reservation management device 100 determines that the obtained item information indicates the “item's absence” (YES in S42), reservation management device 100 sets reservation availability in the reservation data to “available” (S43).

When reservation management device 100 determines that the obtained item information indicates “item's presence” (NO in S42), reservation management device 100 sets reservation availability in the reservation data to “not available” (S44).

Return back to the description of FIG. 9 again.

Controller 102 stores the generated reservation data into storage device 103 (S5).

Next, terminal 310 transmits a request for reservation data (S6).

Then, reservation management device 100 transmits the reservation data stored in storage device 103 to terminal 310 in response to the received request for reservation data (S7).

Terminal 310 receives the reservation data from reservation management device 100, creates UI 321 according to the received reservation data, and displays UI 321 (S8).

Terminal 310 receives an operation to UI 321 and transmits a reservation request based on the received operation to reservation management device 100 (S9).

Reservation management device 100 receives the reservation request from terminal 310, accepts the reservation based on the received reservation request, and updates the reservation data (S10). Specifically, when reservation management device 100 receives the reservation request for compartment A as shown in FIG. 7, reservation management device 100 changes the reservation availability corresponding to compartment A in the reservation data from “available” to “not available.”

Then, reservation management device 100 issues and transmits an unlock key to terminal 310 (S11). The unlock key is, for example, an unlock key for unlocking the lock of each compartment of the at least one delivery cabinet, and an unlock key corresponding to a function of unlocking the compartment. The unlock key may be, for example, a passcode such as a password number of a compartment, a two-dimensional bar code, and a bar code. Moreover, when a lock can be opened by terminal 310 and a delivery cabinet communicating with each other, the unlock key may be information for unlocking through the communication.

[1-3. Advantageous Effects Etc.]

The reservation management method according to the present embodiment includes: obtaining item information that indicates presence or absence of an item in each compartments A to G of delivery cabinets 210 and 220, and declining a reservation for a compartment in which an item is already placed, and accepting a reservation for a compartment in which an item is not placed. For this reason, it is possible to efficiently increase a use rate of the compartment. In addition, a delivery service provider can deliver an item to a reserved compartment of a delivery cabinet and place the item in the reserved compartment without looking for an available compartment. Accordingly, for example, the delivery service provider can decrease a distance traveled for delivery by a vehicle in order to look for the available compartment, and reduce the energy consumption of the vehicle.

Moreover, the reservation management method according to the present embodiment further includes regularly determining, for each compartment of delivery cabinets 210 and 220, a current charge for use of the compartment according to demand information relating to a current demand for the compartment, and in the accepting of the reservation, a reservation for the compartment is accepted as the current charge determined in the regularly determining. In other words, since a charge for a compartment of a delivery cabinet is varied according to demand information about a demand for the compartment, it is possible to appropriately adjust the charge so as to increase profits from the charge of the compartment.

Moreover, in the reservation management method according to the present embodiment, the demand information indicates at least one of a use record of the compartment of delivery cabinets 210 and 220, a use rate of compartments of other delivery cabinets in the vicinity of delivery cabinets 210 and 220, a time of year when reservations are made, an installation position of delivery cabinets 210 and 220, and an attribute of the compartment. With this configuration, it is possible to appropriately adjust a charge of a compartment of a delivery cabinet according to at least one of a use record of the compartment, a use rate of compartments of other delivery cabinets in the vicinity of the delivery cabinet, a time of year when reservations are made, an installation position of the delivery cabinet, and an attribute of the compartment.

Moreover, in the reservation management method according to the present embodiment, in the regularly determining, the current charge is determined so as to be a highest charge according to the use record of the compartment. With this configuration, it is possible to appropriately adjust a charge for a compartment of a delivery cabinet so as to increase profits from the charge of the compartment.

### Embodiment 2

Next, the following describes Embodiment 2.

In reservation management device 100 according to Embodiment 1, controller 102 determines the charge for use of each of compartments A to G of delivery cabinets 210 and 220 according to the demand information, but the present disclosure is not limited to this. The charge may be determined according to bidding by delivery service providers.

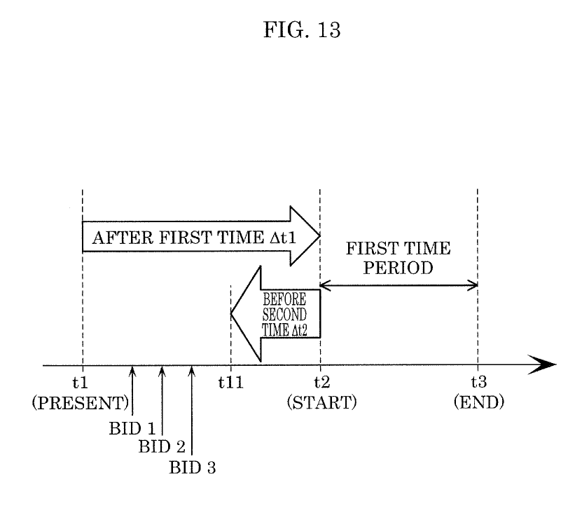

Here, bidding for a compartment of a delivery cabinet in Embodiment 2 will be described with reference to FIG. 13.

FIG. 13 is a diagram illustrating one example of a process for bidding for a compartment of a delivery cabinet by delivery service providers.

A bid is, for example, a bid for use of any compartment of a delivery cabinet in a first time period ranging from starting time t2 to ending time t3, starting time t2 being after first time Δt1 from current time t1. Bids are received until time t11 before second time Δt2 from starting time t2. FIG. 13 shows, as an example, a case in which three bids are received until time t11. It should be noted that first time Δt1 is the same as the one in FIG. 3. Further, second time Δt2 is shorter than first time Δt1.

Next, the following describes the functions of controller 102 when bids are made.

In accepting of a reservation, controller 102 receives via communicator 101 bids for a reservation together with reservation requests from delivery service providers until time t11 before second time Δt2 from starting time t2 of the first time period. Next, in the accepting of the reservation, controller 102 accepts, as the reservation, one of the reservation requests corresponding to the highest bid of the highest bid price among bid prices indicated by the respective bids. Subsequently, controller 102 determines a charge for use of the compartment bid for in the first time period so as to be the highest bid price of the highest bid. For this reason, it is possible to easily set the charge for use of the compartment bid for to a higher charge.

Here, in the accepting of the reservation, when there are the highest bids (i.e., more than two), controller 102 may randomly select, as a reservation, one of reservation requests corresponding to the highest bids, and accept the randomly selected reservation request. Accordingly, even when there are the highest bids, it is possible to easily accept a reservation.

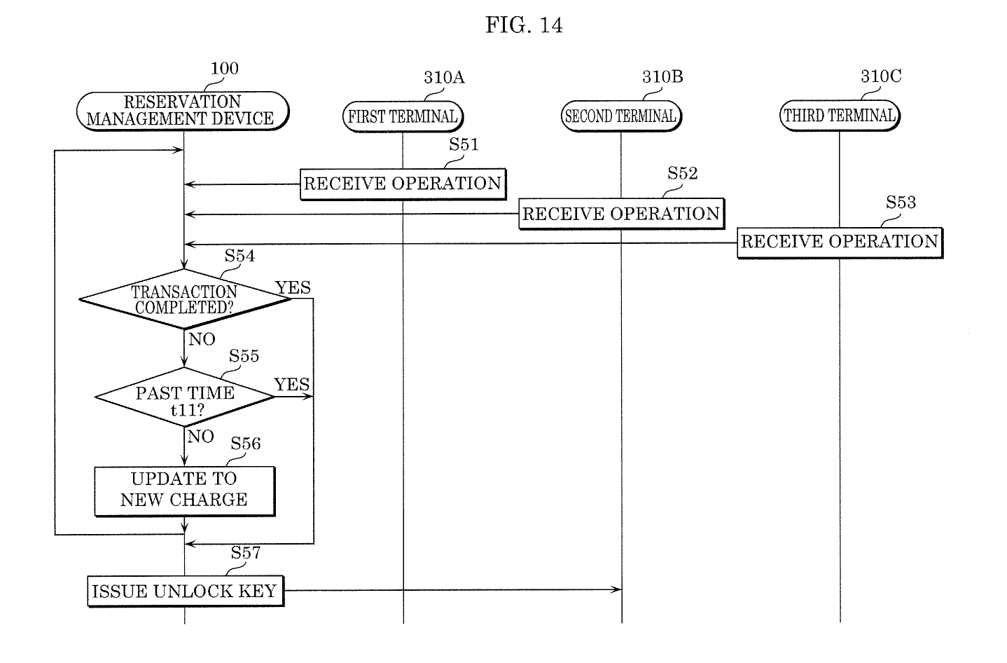

FIG. 14 is a sequence diagram illustrating one example of determining a charge according to a result of bidding in a reservation management system according to Embodiment 2. Here, the following describes, as an example, a case in which delivery service providers bid using first terminal 310A, second terminal 310B, and third terminal 310C, respectively.

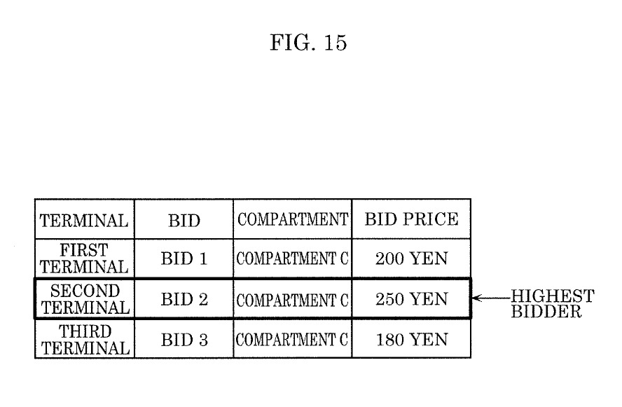

First, first terminal 310A, second terminal 310B, and third terminal 310C each receive an operation for bidding and transmit a bid indicated by the received operation to reservation management device 100 (S51 to S53). As shown in FIG. 15, the bids to be transmitted to reservation management device 100 each include information for identifying a corresponding one of first terminal 310A, second terminal 310B, and third terminal 310C, information for specifying a compartment of a delivery cabinet, and a bid price for the compartment. It should be noted that FIG. 15 shows one example of bidding by each terminal.

Upon receiving a bid for compartment C, reservation management device 100 determines whether a transaction is completed (S54). Specifically, when reservation management device 100 determines that the bid price of the received bid exceeds a threshold price, reservation management device 100 may determine that the bid of the bid price exceeding the threshold price has been accepted, and complete a transaction. Moreover, when reservation management device 100 receives information for forcibly terminating a transaction from a terminal of an owner of delivery cabinet 210 having compartment C, reservation management device 100 may accept a bid of the highest bid price among bids made up to the moment of the forced termination without waiting for time t11 to pass, and determine that the transaction is completed.

When reservation management device 100 determines that the transaction is completed (YES in S54), reservation management device 100 proceeds to step S57. When reservation management device 100 determines that the transaction is not completed (NO in S54), reservation management device 100 proceeds to step S55.

In step S55, reservation management device 100 determines whether time t11 has elapsed (S55).

When reservation management device 100 determines that time t11 has elapsed (YES in S55), reservation management device 100 proceeds to step S57.

When time t11 has not elapsed (NO in S55), reservation management device 100 updates the current charge to a less expensive charge (S56), and receives bids again as in steps S51 to S53. It should be noted that in receiving next bids, reservation management device 100 may receive bids from other terminals in addition to a bid from any of first terminal 310A, second terminal 310B, and third terminal 310C.

In step S57, reservation management device 100 determines a current charge so as to be the highest bid price of the highest bid, and issues an unlock key to a terminal that has made the highest bid. For example, in the case of FIG. 15, because bid 2 made by second terminal 310B is the highest bid relative to the bid prices of bids 1 and 3, an unlock key is issued to second terminal 310B having made bid 2.

### Embodiment 3

Next, the following describes Embodiment 3.

Reservation management device 100 may further limit a reservation for a compartment of a delivery cabinet according to an attribute of the compartment and an attribute of an item.

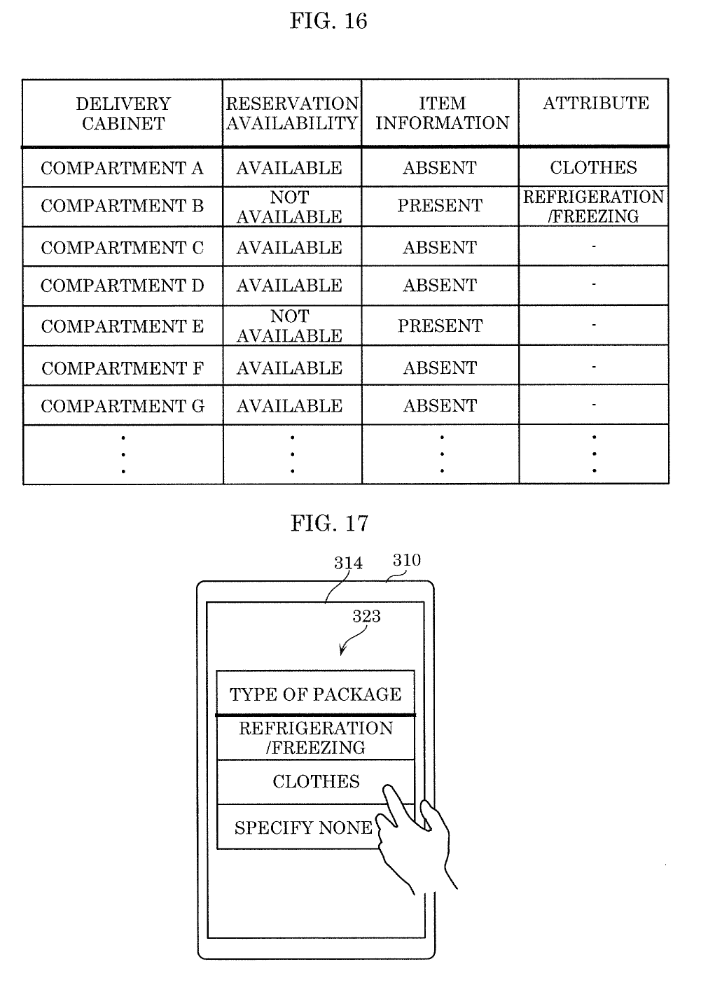

FIG. 16 is a diagram illustrating one example of reservation data including an attribute of each compartment of a delivery cabinet.

As shown in FIG. 16, attributes are added to reservation data of compartments A and B. Here, each of the attributes indicates an additional function of a corresponding one of the compartments. For example, in FIG. 16, compartment A has a function of storing clothes, and compartment B has a function of holding an item in a refrigerated or frozen state. Further, attributes may include an attribute indicating the size of a compartment of a delivery cabinet in addition to an attribute indicating a function such as “clothes” and “refrigeration/freezing.”

Next, the following describes the functions of controller 102 when a reservation is limited through use of attributes.

Controller 102 obtains an attribute associated with at least one compartment of delivery cabinets 210 and 220 via communicator 101. Next, in accepting of a reservation, regarding a reservation for the at least one compartment to which the attribute is added, controller 102 obtains, from terminal 310 via communicator 101, an attribute of an item to be delivered by a delivery service provider, together with a request for the reservation for the at least one compartment. Subsequently, in the accepting of the reservation, regarding the reservation for the at least one compartment to which the attribute is added, controller 102 limits the reservation for the at least one compartment according to the obtained attributes of the item and the at least one compartment to be reserved.

Specifically, in the limiting of the reservation, controller 102 may compare the obtained attribute of the item and the obtained attribute of the at least one compartment, and limit the reservation by prohibiting the reservation to be made to deliver the item when the obtained attribute of the item and the obtained attribute of the at least one compartment are not in a predetermined correspondence relationship.

As stated above, because reservations are limited according to attributes, the delivery service provider can easily reserve a compartment of a delivery cabinet that has an attribute suitable to an attribute of an item without looking for the compartment having the suitable attribute. Accordingly, for example, the delivery service provider can decrease a distance traveled for delivery by a vehicle in order to look for the compartment having the attribute suitable to the attribute of the item, and reduce the energy consumption of the vehicle. Further, since the delivery service provider cannot reserve a compartment of a delivery cabinet that has an attribute having no correspondence relationship with an attribute of an item, it is possible to prevent delivery of an item to a compartment of a delivery cabinet that has an unsuitable attribute.

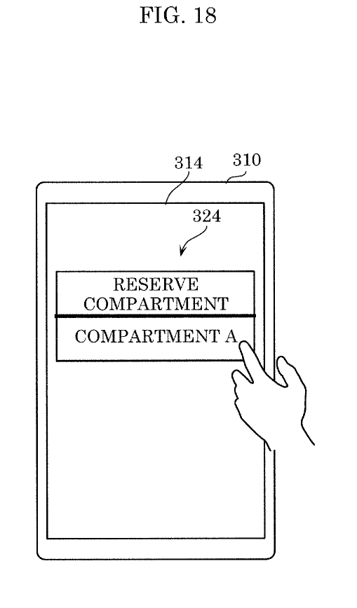

In this case, first, terminal 310 obtains reservation data shown in FIG. 16. Then, as shown in FIG. 17, terminal 310 causes display 314 to display UI 323 for the delivery service provider to input an attribute of an item to be delivered. For example, when “clothes” is selected on UI 323, terminal 310 determines whether compartment A having a correspondence relationship with “clothes” can be reserved according to the obtained reservation data. Then, since reservation availability of compartment A indicates “available,” terminal 310 causes display 314 to display UI 324 for reserving for compartment A as shown in FIG. 18.

It should be noted that the present embodiment is not limited to this, and when “clothes” is selected on UI 323, for example, terminal 310 may transmit “clothes” as an attribute of an item to be delivered to reservation management device 100. In this case, reservation management device 100 determines whether compartment A having a correspondence relationship with “clothes” indicated by the received attribute can be reserved. Because the reservation availability of compartment A indicates available according to the reservation data shown in FIG. 16, reservation management device 100 may transmit the reservation data including compartment A to terminal 310. In consequence, as shown in FIG. 18, terminal 310 causes display 314 to display UI 324.

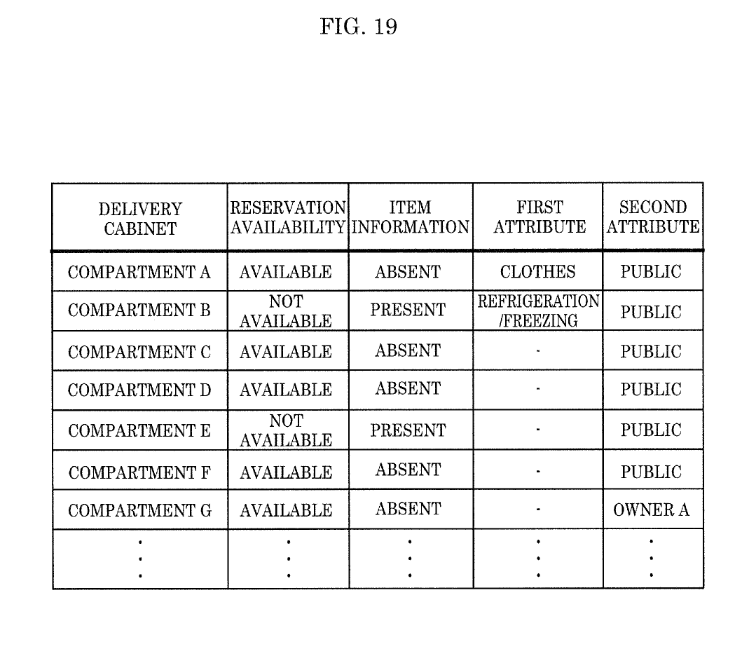

FIG. 19 is a diagram illustrating one example of reservation data including an attribute of each compartment of a delivery cabinet.

In the reservation data shown in FIG. 19, a second attribute that indicates whether a compartment is a public compartment or a private compartment is added in addition to a first attribute indicating an additional function of the compartment.

Next, the following describes the functions of controller 102 when a reservation is limited through use of the second attribute.

In accepting of a reservation, when controller 102 receives reservation requests from delivery service providers until a time before second time Δt2 from starting time t2 of the first time period, controller 102 accepts one of the reservation requests having the highest predetermined priority of an obtained attribute of an item relative to an obtained attribute of a compartment of a delivery cabinet. Specifically, regarding delivery cabinet 220 having compartment G whose second attribute indicates owner A, when controller 102 receives reservation requests from delivery service providers, controller 102 may accept one of the reservation requests for a place of delivery of an item for owner A in preference to the other reservation requests for places of delivery of items for recipients other than owner A. In other words, when controller 102 receives, from the delivery service providers, the reservation request for the place of delivery of the item for owner A and the reservation requests for the places of delivery of the items for the recipients other than owner A, controller 102 accepts not the reservation requests for the places of delivery of the items for the recipients other than owner A but the reservation request for the place of delivery of the item for owner A.

For this reason, when a priority is set higher when a recipient is an owner of a compartment of a delivery cabinet, the delivery service providers use the compartment when delivering an item for the owner. Accordingly, it is possible to improve the convenience of owners and promote the widespread use of delivery cabinets.

### Others

Although each of the delivery cabinet includes the detector that detects the item inside in the aforementioned embodiments, each delivery cabinet need not include the detector. In the case that the delivery cabinet does not include the detector, when a delivery service provider places an item in a compartment of the delivery cabinet, a mobile terminal may be used to transmit, as item information, information indicating that the item has been placed in the compartment. Further, in this case, when a recipient picks up the item in the compartment, the mobile terminal may be used to transmits, as item information, information indicating that the item has been picked up from the compartment.

It should be noted that in each of the aforementioned embodiments, the structural components each may be configured using dedicated hardware or may be each realized by executing a software program suitable for the structural component. Each of the structural components may be implemented by a program executing unit, such as a CPU or a processor, reading and executing a software program recorded on a recording medium, such as a hard disk or a semiconductor memory. Here, the software for implementing the reservation management method, the reservation management device, etc. in each of the aforementioned embodiments is a program such as that described below.

In other words, this program causes a computer to execute a reservation management method including: obtaining item information from at least one compartment of a delivery cabinet or a communication terminal via a network, the item information indicating presence or absence of an item in the at least one compartment; and accepting a reservation for a first compartment from a delivery service provider, and declining a reservation for a second compartment from the delivery service provider, in a first time period starting after a first time from a current time, the first compartment being a compartment among the at least one compartment for which the item information indicates the absence of the item, the second compartment being a compartment among the at least one compartment for which the item information indicates the presence of the item.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is useful as a reservation management method and a reservation management device that can achieve further improvement.

What is claimed is:

1. A reservation management method, comprising the following executed using a computer:
obtaining item information from at least one compartment of a delivery cabinet or a communication terminal via a network, the item information indicating presence or absence of an item in the at least one compartment; and
accepting a reservation for a first compartment from a delivery service provider, and declining a reservation for a second compartment from the delivery service provider, in a first time period starting after a first time from a current time, the first compartment being a compartment among the at least one compartment for which the item information indicates the absence of the item, the second compartment being a compartment among the at least one compartment for which the item information indicates the presence of the item.

2. The reservation management method according to claim 1, further comprising:
regularly determining, for each of the at least one compartment, a current charge for use of the compartment according to demand information relating to a current demand for the compartment,
wherein in the accepting of the reservation, a reservation for the at least one compartment is accepted at the current charge determined in the regularly determining.

3. The reservation management method according to claim 2,
wherein the demand information indicates at least one of a use record of the at least one compartment, a use rate of compartments of other delivery cabinets in the vicinity of the delivery cabinet, a time of year when reservations are made, an installation position of the delivery cabinet, and an attribute of the at least one compartment.

4. The reservation management method according to claim 2,
wherein in the regularly determining, the current charge is determined so as to be a highest charge according to the use record of the at least one compartment.

5. The reservation management method according to claim 1,
wherein the accepting of the reservation includes:
receiving bids for the first compartment together with requests for the reservation for the first compartment from delivery service providers until a time before a second time from a starting time of the first time period; and
accepting the reservation for the first compartment that corresponds to one of the requests that is received with a highest bid of a highest bid price among bid prices respectively indicated by the bids,
the reservation management method further comprising:
determining a charge for use of the first compartment so as to be the highest bid price in the first time period.

6. The reservation management method according to claim 5,
wherein in the accepting of the reservation, when there are a plurality of highest bids, one of requests for the reservation for the first compartment corresponding to the plurality of highest bids is randomly selected, and the randomly selected reservation request is accepted as the reservation for the first compartment.

7. The reservation management method according to claim 1, further comprising:
obtaining an attribute associated with the first compartment of the delivery cabinet,
wherein the accepting of the reservation includes, regarding a request for the reservation for the first compartment:
obtaining, together with the request, an attribute of an item to be delivered by the delivery service provider; and
limiting the reservation for the first compartment in accordance with the obtained attribute of the item and the attribute of the first compartment.

8. The reservation management method according to claim 7,
wherein in the limiting, the obtained attribute of the item and the attribute of the first compartment are compared, and when the obtained attribute of the item and the attribute of the first compartment are not in a predetermined correspondence relationship, the reservation for the first compartment necessary for delivering the item is limited by prohibiting the reservation for the at least one compartment.

9. The reservation management method according to claim 7,
wherein in the accepting of the reservation, when requests for the reservation for the first compartment are received from delivery service providers until a time before a second time from a starting time of the first time period, a reservation request is accepted as the reservation for the first compartment from among the requests, the reservation request having a highest predetermined priority of the obtained attribute of the item relative to the obtained attribute of the first compartment.

10. A reservation management device comprising a computer,
wherein the computer:
obtains item information from at least one compartment of a delivery cabinet or a communication terminal via a network, the item information indicating presence or absence of an item in the at least one compartment; and
accepts a reservation for a first compartment from a delivery service provider, and declines a reservation for a second compartment from the delivery service provider, in a first time period starting after a first time from a current time, the first compartment being a compartment among the at least one compartment for which the item information indicates the absence of the item, the second compartment being a compartment among the at least one compartment for which the item information indicates the presence of the item.
